(19) United States
(12) Patent Application Publication
(10) Pub. No.: US 2026/0131605 A1
(43) Pub. Date: May 14, 2026

(54) SYSTEMS AND METHODS FOR TRAILER SWAY MONITORING AND MITIGATION

(71) Applicant: Rivian IP Holdings, LLC, Irvine, CA (US)

(72) Inventors: Fai Yeung, Palo Alto, CA (US); Abhiram Krishnan, Surrey (CA); Aleksa Katic, Cuprija (RS); Strahinja Stefanovic, Sokobanja (RS)

(21) Appl. No.: 19/210,082

(22) Filed: May 16, 2025

Related U.S. Application Data
(60) Provisional application No. 63/719,059, filed on Nov. 11, 2024.

(51) Int. Cl. B60D 1/30; B60W 10/18; B60W 50/14

(52) U.S. Cl. CPC B60D 1/305; B60W 10/18; B60W 50/14; B60W 2050/143; B60W 2050/146; B60W 2300/14; B60W 2420/403; B60W 2420/408; B60W 2420/54; B60W 2510/083; B60W 2520/10; B60W 2530/205; B60W 2555/20; B60W 2556/10

(57) ABSTRACT

Vehicles, systems, and methods for trailer sway mitigation are provided. In accordance with some embodiments of this disclosure, a vehicle includes at least one sensor configured to record data of a trailer coupled to the vehicle, processing circuitry configured to monitor a position of the trailer based on at least one feature point of the recorded data, and to determine an amount of trailer sway based on the monitored position, and a warning system configured to trigger an alert to a driver of the vehicle in response to the determined amount of trailer sway exceeding a threshold. Triggering the alert may cause the trailer sway to be mitigated based on a response by the driver or based on an action by the processing circuitry, such as applying a brake to the trailer or adjusting a torque of the vehicle.

### CROSS REFERENCE TO RELATED APPLICATIONS

This application claims the benefit of U.S. Provisional Patent Application No. 63/719,059, filed Nov. 11, 2024, which is hereby incorporated by reference herein in its entirety.

### INTRODUCTION

The present disclosure is directed to systems and methods for monitoring and mitigation of trailer sway. More specifically, the present disclosure is directed to using sensors (including, but not limited to vision sensors) of a vehicle to monitor the status of a trailer being towed by the vehicle and to mitigating trailer sway (e.g., through alerts and/or corrective actions) if a threshold amount of trailer sway occurs.

### SUMMARY

Vehicles may incorporate data from onboard sensors (e.g., at least one camera, and/or any other light-based, radiowave-based, ultrasound-based, or other senor) for any number of applications. In accordance with embodiments of this disclosure, cameras or other sensors (including any sensor that can be used to generate spatiotemporal data) are used to monitor the status (in particular, the possible swaying) of a trailer or other cargo that is being towed by the vehicle. Based on the monitoring, an alert may be issued to the driver to mitigate the swaying, or the vehicle may be controlled (e.g., by a software system acting in response to the monitoring indicating that a degree of sway has exceeded a threshold) to mitigate the swaying.

Vehicles, systems, and methods for trailer sway mitigation are provided. In accordance with some embodiments of this disclosure, a vehicle includes at least one sensor configured to record data of a trailer coupled to the vehicle, processing circuitry configured to monitor a position of the trailer based on at least one feature point of the recorded data, and to determine an amount of trailer sway based on the monitored position, and a warning system configured to trigger an alert to a driver of the vehicle in response to the determined amount of trailer sway exceeding a threshold. Triggering the alert may cause the trailer sway to be mitigated based on a response by the driver or based on an action by the processing circuitry, such as applying a brake to the trailer or adjusting a torque of the vehicle.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative hitch that may be used to connect a trailer to a vehicle, in accordance with some embodiments of this disclosure;

FIG. 2 shows an electric vehicle configured to monitor the swaying of a trailer that is mechanically coupled to the electric vehicle, in accordance with some embodiments of this disclosure;

FIG. 3 is a flowchart of an illustrative hardware and software-based method for monitoring the swaying of a trailer that is mechanically coupled to a vehicle, in accordance with some embodiments of this disclosure;

FIG. 4 shows an illustrative system including a trailer equipped with a QR code, and a computer vision system to track the QR code for trailer sway monitoring, in accordance with some embodiments of this disclosure;

FIG. 5 shows an illustrative system of a vehicle using computer vision analysis to track trailer sway based on the position of a QR, in accordance with some embodiments of this disclosure;

FIG. 6 is an illustrative graphical depiction of trailer sway over time, in accordance with some embodiments of this disclosure;

FIG. 7 is a flowchart of an illustrative method for issuing an alert in response to the detection of trailer sway, in accordance with some embodiments of this disclosure;

FIG. 8 shows an illustrative display panel including a trailer sway alert, in accordance with some embodiments of this disclosure;

FIG. 9 is a flowchart of an illustrative method for trailer sway monitoring and mitigation, in accordance with some embodiments of this disclosure; and

FIG. 10 is a flowchart of an illustrative method for trailer sway monitoring calibration and trailer sway mitigation, in accordance with some embodiments of this disclosure.

### DETAILED DESCRIPTION

Trailer sway, also known as fishtailing, refers to undesired side-to-side movement of a trailer that is being towed. Trailer sway can be caused by various factors, including improper weight distribution, poor trailer design, and challenging driving conditions.

One approach to mitigate trailer sway is to address improper weight distribution. To avoid improper weight distribution, heavier items should be placed in the center of the trailer, with lighter items distributed evenly on either side. For example, one approach is to place 60% of the weight in front of the trailer axle and 40% of the weight behind it. When using a hitch, the hitch weight can be between 10-12% of the trailer's total weight, and the hitch weight should be considered when distributing the weight. Embodiments of this disclosure may include determining proper weight distribution (e.g., based on data of a trailer and optionally further based on inputs regarding the contents of the trailer) and identifying improper weight distribution of a trailer. In response to an identification of improper weight distribution, an alert may be triggered to a driver of the vehicle towing the trailer.

Another approach to mitigate trailer sway is to address poor trailer design. Trailers with misaligned wheels or poorly designed frames are more prone to sway, especially when driven improperly. Regular servicing and inspections can help ensure that a trailer is of suitable quality and condition. Embodiments of this disclosure may include inspecting a trailer before or during transit and determining whether the trailer is in proper condition for towing. In response to a determination that the trailer is not in proper condition for towing, an alert may be triggered to a driver of the vehicle towing the trailer.

Another approach to mitigate trailer sway is to address poor driving conditions (e.g., poor weather conditions, such as poor ambient lighting or precipitation, or poor underlying conditions, such as tight, steep, slick, icy, pothole-ridden, or otherwise impaired asphalt, or driving over any non-asphalt terrain). Poor driving conditions may result in delaying transportation or choosing longer and less dangerous routes. For example, trailer sway can be caused by poor driving conditions such as tight turns, steep roads, high speeds, crosswinds, precipitation, slick pavement, and passing vehicles. Rather than delay transportation or choose suboptimal routes, embodiments of this disclosure may include determining current driving conditions and mitigating trailer sway based on the determined driving conditions.

Severe trailer sway can negatively impact both the trailer and the towing vehicle. For example, trailer sway may damage the trailer and/or the towing vehicle. The risk of trailer sway may be increased when driving at high speeds, which can amplify the effects of trailer sway. Embodiments of this disclosure may include determining that trailer sway exceeds a threshold (e.g., the threshold being associated with high risk) and, based on exceeding the threshold, triggering a warning to a driver of the electric vehicle and/or modifying operation of the electric vehicle to mitigate the trailer sway (e.g., by applying a brake to the trailer, applying a brake to the electric vehicle, adjusting a trajectory of the electric vehicle, modifying a torque of the electric vehicle, or otherwise assisting with the driving of the electric vehicle to mitigate sway).

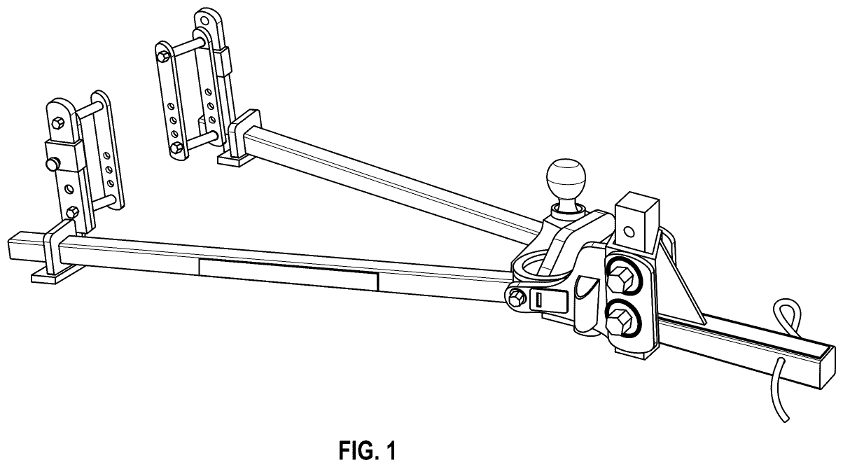

Without systems and methods such as those provided in this disclosure, trailer sway may only be mitigated by approaches that are manually intensive or overly reliant on mechanical stabilization, such as proper trailer loading, the use of anti-sway devices (e.g., a weight distribution hitch of FIG. 1), cautious driving, and regular equipment inspections. However, such approaches to mitigate trailer sway can be tedious and can require a significant amount of manual intervention, including well-planned pre-trip inspections, which may not be prone to human error.

In some embodiments of this disclosure, sensors and supporting algorithms (e.g., computer vision algorithms, which may include the use of neural network processing, deep learning algorithms, or any other suitable artificial intelligence) may be applied to monitor trailer load distribution (e.g., to maintain about 60% of the load toward the front) and actively determine that trailer equipment and tires (e.g., to monitor inflation levels) conform to predetermined specifications. In some embodiments, vehicles and methods of this disclosure may be used in connection with anti-sway devices (e.g., trailer sway control devices or weight distribution hitches designed to reduce sway) to further mitigate trailer sway. That is, embodiments of this disclosure may combine any suitable mechanical stabilization with an electronic, computer-vision based approach to monitor and mitigate trailer sway.

As mentioned, FIG. 1 shows a weight distribution hitch, which is one example of a mechanical anti-sway device. The weight distribution hitch may be used as a mechanical stabilization tool in connection with embodiments of this disclosure to provide various approaches for mitigating sway.

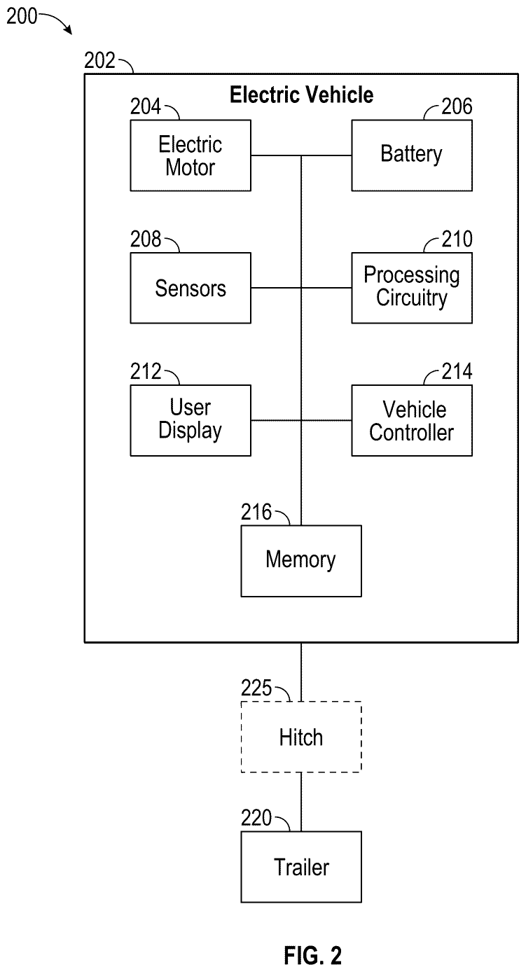

FIG. 2 shows a block diagram of a system 200 for mitigating the sway of trailer 220 when it is towed by electric vehicle 202 (with or without hitch 225). Although system 200 specifically includes an electric vehicle, embodiments of this disclosure may be applied to any vehicle (e.g., including internal combustion engine, hybrid electric, or any other type of vehicle). Although system 200 specifically includes trailer 220 being towed by electric vehicle 202, embodiments of this disclosure may similarly be applied to any cargo being towed by the vehicle. Electric vehicle 202 is configured to mitigate the sway of trailer 220 based at least in part on spatiotemporal data from sensors 208 (e.g., including at least one camera, such as a truck bed camera or a vehicle-surrounding camera, an ultrasonic sensor, LIDAR sensor, RADAR sensor, inertial measurement unit, any other suitable sensor, or any combination thereof) and processing of the spatiotemporal data at processing circuitry 210. Electric vehicle 202 also includes electric motor 204, battery 206, user display 212, vehicle controller 214, and memory 216, any one or more of which may be used to mitigate trailer sway (e.g., via an alert and/or via controlling movement of electric vehicle 202). For example, electric motor 204, battery 206, and/or vehicle controller 214 may be operated to mitigate trailer sway (e.g., by applying proper braking, torque, steering, other control, or any combination thereof). For another example, user display 212 may be operated to mitigate trailer sway (e.g., by triggering a warning that informs a driver about a current trailer sway status and/or causes the driver to mitigate trailer sway). For another example, conditions stored in memory 216 may be used to determine whether trailer sway is within, or in excess of, a tolerable limit. In all of those examples, the corresponding operations and/or determinations may be executed, at least in part, by processing circuitry 210.

Memory 216 may store information that is used in connection with trailer sway detection (e.g., in connection with method 300, method 700, or method 900, any other suitable trailer sway detection process, or any combination thereof). For example, memory 216 may contain trailer information, trailer sway limits (e.g., based on vehicle speed, lane properties, vehicle type, environmental conditions, underlying traction conditions, any other factors, or any combination thereof), logical processing sequences, warning types, one or more computer vision algorithms, augmented reality processing data, artificial intelligence processing data, any other suitable data, or any combination thereof.

In connection with data stored in memory 216, and further in connection with some embodiments of this disclosure for monitoring and mitigating trailer sway, processing circuitry 210 may include one or more processing components (e.g., including, but not limited to, a GPU) configured to execute one or more computer vision algorithms (e.g., feature point monitoring, feature point extraction, optical signature detection, three-dimensional (3D) pose estimation, sensor occlusion detection, lane detection, ultrasonic sensor processing, a motion tracking algorithm, any other suitable computer vision algorithm, or any combination thereof), one or more logical operations (e.g., to determine whether a turn signal is activated; to determine a reference motion trajectory such as based on vehicle speed, steering angle, and/or trailer data; to determine one or more threshold limits associated with trailer sway, e.g., based on the reference motion trajectory and/or environmental conditions; to determine whether a trailer is being towed; to determine whether to issue a warning and to further determine what type of one or more warnings to issue; to determine whether to engage electric motor 204, battery 206, and/or vehicle controller 214 to mitigate trailer sway; any other suitable logical operations; or any combination thereof), one or more computational operations (e.g., to filter trailer sway data; to obtain vehicle and/or trailer data, including a reference motion trajectory, based on sensor data; any other computational operation; or any combination thereof), augmented reality-based algorithms, artificial intelligence-based algorithms, or any combination thereof.

In some embodiments, memory 216 includes a non-transitory computer-readable medium having non-transitory computer-readable instructions encoded thereon that, when executed by processing circuitry 210, cause the processing circuitry to perform at least part of any method described in connection with this disclosure (e.g., method 300, method 700, method 900, method 1000, any other suitable method, or any combination thereof). That is, the processing circuitry 210 may be coupled to the memory 216 to allow the processing circuitry 210 to read data stored in memory 216 and execute various operations (e.g., in connection with any one or more of the methods described in this disclosure) based on the data stored in memory 216.

FIG. 2 further shows how electric vehicle 202 pulls trailer 220. In some embodiments of this disclosure, instead of towing a trailer, electric vehicle 202 tows any other suitable load (e.g., an automobile, boat, other suitable vehicle, any other suitable cargo, or any combination thereof), and sway monitoring and mitigating (as described in connection with a trailer 220, for illustrative purposes only) can similarly be achieved. Trailer 220 may be connected to electric vehicle 202 via hitch 225 (e.g., which may be the hitch of FIG. 1), or by any other suitable mechanical fastener. While hitch 225 may be configured to reduce sway of trailer 220 based on mechanical stabilization, electric vehicle 202 may be configured to further reduce trailer sway or any other cargo sway using embodiments of this disclosure.

In some embodiments, data from sensors 208 is processed at processing circuitry 210 to determine that trailer 220 and/or hitch 225 should be inspected. That is, processing circuitry 210 may be configured to determine that there is a mechanical issue (e.g., an underinflated tire, a loose or misaligned connection, a structurally compromised component, any other mechanical issue, or any combination thereof), a weight distribution issue (e.g., the weight of the trailer is not distributed optimally, or is not appropriate for the corresponding hitch), an environmental issue (e.g., road conditions are not suitable to keep trailer sway below a threshold), any other issue that could affect trailer towing, or any combination thereof.

As mentioned, in response to determining that trailer sway exceeds a threshold (which may be any suitable threshold, e.g., that corresponds to a trailer currently swaying by a certain amount, or that corresponds to a trailer being expected to begin swaying by a certain amount) processing circuitry 210 may be configured to mitigate the trailer sway using any one or more mitigation technique described in this disclosure, or any other suitable approach.

The sensor-based trailer sway mitigation of this disclosure leverages sensors 208 on electric vehicle 202 and computing resources (i.e., processing circuitry 210 and memory 216) of electric vehicle 202 to mitigate trailer sway. In some embodiments, the trailer sway mitigation includes the trigger of alerts to a driver of electric vehicle 202 over user display 212. In some embodiments, the alerts are delivered similarly to other driver alerts (e.g., such as alerts based on veering outside of a lane, or being too close to an obstacle on the road).

In some embodiments, processing circuitry 210 relies on at least one feature point of trailer 220 to determine an amount of trailer sway. The at least one feature point may be any surface, edge, or other mechanical component of trailer 220, or any combination thereof. The at least one feature point may be an optical signature, such as a QR code, bar code, or any other pattern than may be scanned and recognized. Processing circuitry 210 may be configured to detect the optical signature.

Herein, a QR code is included as one illustrative and non-limiting example of an optical signature that is used in connection with some embodiments of this disclosure. It will be understood that any other optical signature may be used in place of, or in addition to, a QR code. The QR code may be applied to trailer 220, in which case the QR code may be one of the at least one feature point. Processing circuitry 210 may be configured to identify and track the location of the QR code, and may be further configured to monitor trailer sway based on the tracked QR code location. Processing circuitry 210 may be further configured to perform 3D pose estimation based on a position and/or orientation of the QR code, and the 3D pose estimation may be used in determining the amount of trailer sway.

In some embodiments, by comparing the movements of a feature point (e.g., the optical signature, or any suitable feature point) with a baseline position (e.g., a reference motion trajectory based on real-time movement of the vehicle towing the trailer), the degree of trailer sway is determined (e.g., at processing circuitry 210) based on the deviation of tracked motion from the expected reference motion. A visual display (e.g., presented on user display 212) of the trailer sway may be shown alongside other displays (e.g., truck bed and rear views) that are included in electric vehicle 202. If the trailer sway exceeds a threshold, an alert may be triggered on user display 212 (e.g., in the entertainment panel, or in any other screen or suitable portion of a screen). This alert may warn the driver to take steps to mitigate trailer sway, such as slowing down or fixing an aspect of the trailer setup.

In some embodiments, deep learning-based vision algorithms (e.g., which may be classified as computer vision algorithms or artificial intelligence-based algorithms, as mentioned above) are implemented by processing circuitry 210 to identify and extract feature point data (e.g., at least one optical signature, or any other suitable visual cues) on trailer 220 or any other cargo that is being towed. Processing circuitry 210 may also execute a motion tracking algorithm to decode the motion trajectory of the trailer (e.g., in real time, or nearly real time) based on the feature point data. The deviation of the tracked motion from a reference motion trajectory can be used to determine the degree of trailer sway. This deviation can be calibrated, mapped, or otherwise used to determine or estimate the magnitude of trailer sway. The trailer sway can be visualized (e.g., on user display 212) using a dedicated gauge, which may be on its own panel of a user display, or which may overlay a truck-bed camera feed or any other view of the trailer 220. If the trailer sway exceeds a predefined threshold (e.g., which may be set by the driver, or which may be automatically set based on details of the trailer, e.g., which may be encoded in the optical signature that is also used for generating feature point data), an alert (e.g., on user display 212, which may be similar to any other warnings configured for electric vehicle 202) is triggered. When the alert is triggered, it causes a color, text, warning message, and/or other visual cue to be presented to the driver of the electric vehicle 202. This visual cue can prompt the driver to mitigate trailer sway by slowing down or stopping the electric vehicle 202 at the earliest possible opportunity. The driver may be further prompted to inspect the trailer 220 and, if necessary, redistribute the load of the trailer 220. In some embodiments, in addition to triggering the alert, processing circuitry 210 may be configured to cause the vehicle to slow down or otherwise modify its trajectory to mitigate the trailer sway.

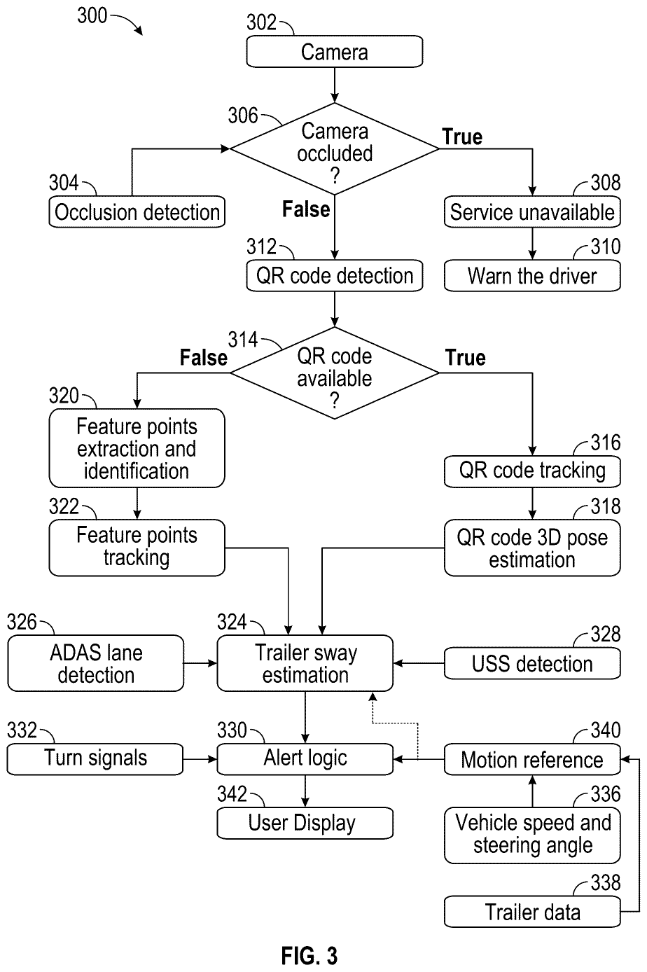

FIG. 3 is an illustrative flowchart of a method 300 including hardware-(e.g., sensors 208) and software-based operations (e.g., executed on processing circuitry 210) that may be used to mitigate trailer sway, in accordance with some embodiments of this disclosure. In some embodiments, method 300 is executed by processing circuitry 210, e.g., in connection with at least one device of sensors 208 and further in connection with data stored in memory 216. As shown by the corresponding blocks of FIG. 3, one or more trailer sway monitoring algorithm steps (e.g., corresponding at least to steps 304, 312, 316-326, and 336-340) may be executed by the processing circuitry.

At step 302, a camera (e.g., the truck bed camera, any other suitable camera, or any other device within the group of sensors 208) provides visual information such as an elevated or side view of the trailer. For vehicles without a truck bed camera (e.g., to provide the elevated view), one or more cameras on or surrounding the rear of the vehicle can be used at step 302.

Occlusion detection data is received from memory (e.g., memory 216) at step 304. At step 306, the processing circuitry determines, based on the data received at steps 302 and 304, whether or not the one or more cameras to be used in trailer sway detection are occluded. If there is occlusion, then the processing circuitry determines that the service (i.e., trailer sway detection) is unavailable at step 308 and issues a corresponding warner to the driver (i.e., of electric vehicle 202) at step 310. In other words, at step 306, a camera occlusion detection algorithm may be used to detect whether the camera is occluded or not. Then, at step 310, an alert system may be configured to issue an alert to the driver of the electric vehicle if camera blockage occurs and limits operation of the trailer sway monitoring system.

In some embodiments, at step 302, a light sensor algorithm may be used to adjust data processing in response to ambient light variations. The light sensor algorithm may cause at least one of the sensors 208, and/or processing circuitry 210, to enhance light detection in low-light conditions, thereby increasing visual sensitivity in relatively dark environments.

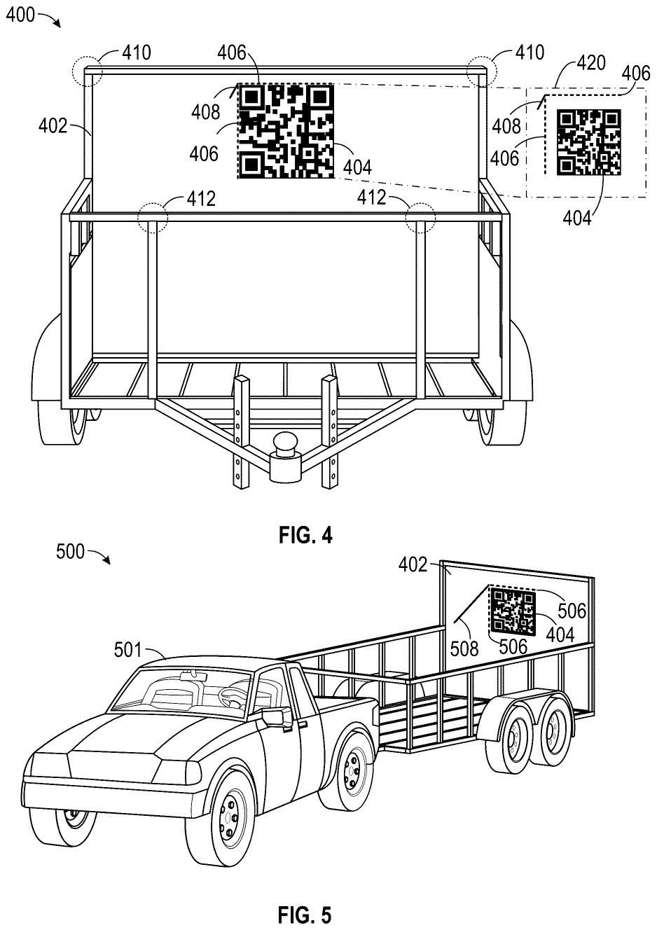

Returning to step 306, if the processing circuitry determines that the camera is not occluded, then the trailer sway detection method 300 proceeds as follows. At step 312, the processing circuitry executes a QR code detection algorithm (e.g., to detect for the presence of a QR code on trailer 220, as further shown and described in connection with FIGS. 4-5) and thus determines, at step 314, whether a QR code is available (i.e., whether a QR code is visible in the data received at step 302). If a QR code is available, the processing circuitry executes QR code tracking at step 316 (e.g., to monitor the position of the QR code) and QR code 3D pose estimation at step 318 (e.g., to monitor the skew of the QR code, which is indicative of the trailer sway). However, if a QR code is not available, then the processing circuitry determines at least one other feature point. In particular, the processing circuitry executes a feature point extraction and identification method at step 320, and then tracks the one or more identified feature point at step 322.

To reiterate, a QR code is shown and/or described in connection with FIGS. 3-5 as one illustrative and non-limiting example of an optical signature. Any other optical signature may be used in place of a QR code without departing from the scope of some embodiments of this disclosure.

Steps 312, 316, 318, 320, and/or 322 may include processing data using a feature point extraction algorithm. The feature point extraction algorithm method may process (e.g., using a GPU unit of processing circuitry 210), as an input, uncompressed frames from one or more camera channels (e.g., based on the data received at step 302). The feature extraction algorithm may further perform feature point identification and extraction (e.g., at step 312 or at step 320). If the algorithm detects the QR code, it may be configured to prioritize that QR code over any other possible feature point for locational extraction and monitoring. In the absence of a QR code, one or more robust feature points (e.g., corners, edges, aesthetic markings, scratches, dents, or any other suitable visual features) may be extracted and selected for monitoring (e.g., at step 320 and/or step 322), such as feature points with strong or distinctive texture characteristics. The feature extraction algorithm may be configured to exhibit invariance with respect to scale, orientation, and rotation. The feature extraction algorithm may also be configured to enforce temporal consistency of extracted feature point monitoring while the vehicle is in motion. For example, feature points that lack temporal consistency may be therefore excluded from the candidate pool of feature points to monitor.

Whether the processing circuitry uses QR code tracking (i.e., based on steps 316-318) or feature point tracking (i.e., based on steps 320-322), the processing circuitry estimates trailer sway at step 324. The trailer sway estimation may occur by calculating an expected position or pose of the QR code/feature point if there was zero trailer sway, and then comparing that expected position or pose to the corresponding tracked value. While method 300 shows a distinction between processing based on QR codes and processing based on feature points, it will be understood that QR codes (or any other optical signature) are a specific type of feature point, and the distinction in method 300 is with respect to features points that are not optical signatures.

In some embodiments, step 324 may include calculating an expected trailer movement without trailer sway. As further explained below, this calculation may be based on the trailer data (e.g., dimensions, weight, as received at step 338), the vehicle data (e.g., speed, steering wheel angle, as received at step 336), a corresponding trailer kinematics model (e.g., as may be processed at step 340), any other suitable data or algorithm, or any combination thereof. The expected trailer movement without sway may be compared to the actual trailer movement with sway, e.g., as obtained from the feature point, to estimate the trailer sway at step 324. For example, differences between the expected trailer movement and the actual trailer movement can indicate the occurrence and magnitude of the trailer sway. When comparing these two signals, processing circuitry 210 may execute any suitable computer vision and/or computational algorithm, e.g., relying on statistical metrics such as correlation. In some embodiments, artificial intelligence algorithms (e.g., recurrent neural networks) can be used to compare those two signals and determine a similarity (e.g., as represented by the similarity score of step 714).

Steps 326 and steps 328 are provided as optional additions to the trailer sway estimation method at step 324. That is, trailer sway estimation can occur based only on data acquired at steps 316-318 or steps 320-322. In addition, trailer sway estimation can occur further based on data acquired at step 326, step 328, or both.

As mentioned, the estimation at step 324 may be further based on step 326 of receiving data from an advanced driver assistance system (ADAS) lane detection algorithm. The ADAS lane detection algorithm data may be used to incorporate lane curve information and improve the accuracy of trailer sway estimations. Additionally, at step 324, the road curvature can be estimated from the lane detection data. Moreover, the ADAS lane detection algorithm sensitivity can be actively adapted during driving (e.g., to account for any dynamic road or lane conditions). For example, trailer sway may be estimated at step 324 based at least in part on comparing a position of the trailer to a position of a lane line, as indicated by the ADAS lane detection algorithm data.

As mentioned, the estimation at step 324 may be further based on step 328 of receiving data from at least one ultrasonic sensor (USS) (e.g., which can be at least one sensor included within sensors 208). For example, a USS data integration algorithm may be used to improve trailer sway detection accuracy. In some embodiments, trailer sway detection based on camera data received at step 302 may be limited by poor lighting conditions or camera faults. In contrast, USS devices on the vehicle are not affected by lighting conditions and can accurately measure signals over short distances. Therefore, USS data can be used as an additional source of information in monitoring trailer sway. In some embodiments, data from USS can be constantly evaluated and can be used to determine, independent of other data, if a trailer is swaying. That is, method 300 can start at step 328 and proceed to 324, bypassing the need for a camera (e.g., if lighting conditions are too poor, occlusion is present, the camera fails, or processing circuitry otherwise determines to rely solely on USS data) to monitor trailer sway. In other embodiments, as shown in FIG. 3, USS data can be combined with camera data to allow for more accurate detection of trailer swaying.

After the processing circuitry estimates trailer swaying at step 324, the amount of estimated trailer sway is communicated to alert logic at step 330. The alert logic at step 330 is configured to generate an alert to the driver based on the trailer sway (e.g., when the trailer sway exceeds a certain threshold). The alert may be configured to have tiers, e.g., with a “yellow” warning when the trailer sway exceeds a first limit, and with a “red” warning when the trailer sway exceeds a second limit, greater than the first.

In some embodiments, data is received at step 332 from a turn signal algorithm, and the alert logic of step 330 is further configured to trigger an alert based on the data from the turn signal algorithm. For example, the turn signal data received at 332 may cause the alert logic of step 330 to determine that a trailer is moving because of a vehicle maneuver, rather than a trailer sway. Thus, the turn signal algorithm providing the data at step 332 may be configured to distinguish between intended directional changes and trailer sway.

In some embodiments, at step 330, the processing circuitry incorporates vehicle speed information, as received at step 336 (e.g., from any suitable vehicle sensor, optionally with additional processing by a computer vision algorithm and/or a computational algorithm). Incorporating the vehicle speed information may include adjusting the trailer sway detection threshold (i.e., the one or more limits associated with triggering a trailer sway warning or other mitigating action) based on the vehicle's driving speed. That is, a threshold indicating the maximum allowable trailer sway (e.g., before triggering an alert) may be determined based at least in part on the vehicle speed. Such a logical or computational operation can be used to refine how trailer sway alerts are generated across various driving conditions.

In some embodiments, at step 330, the processing circuitry incorporates trailer data, as received at step 338 (e.g., from the QR code detected at step 312, and/or from any suitable data stored in memory 216) to control the trailer sway detection threshold based on the trailer data. That is, the threshold indicating the maximum allowable trailer sway (e.g., before triggering an alert) may be determined based at least in part on the trailer weight, trailer volume, or other trailer data.

In some embodiments, at step 340, the processing circuitry combines vehicle speed and steering angle data, as received at step 336, with trailer data, as received at step 338. Thus, the processing circuitry determines motion reference data at step 340. Accordingly, at step 330, the processing circuitry may incorporate the motion reference data to control the trailer sway detection sensitivity. The motion reference data may be determined

Any combination of trailer swaying estimation data received at step 324, turn signal data received at step 332, vehicle speed and steering angle data received at step 336, trailer data received at step 338, and motion reference data received at step 340 may be considered by alert logic of step 330 in determining whether and how to issue an alert related to trailer sway. For example, the threshold indicating the maximum allowable trailer sway may be set based on the motion reference data.

Moreover, the motion reference data received at step 340 may optionally be fed back to the trailer sway estimation algorithm, as executed at step 324. For example, the trailer sway estimation may be determined based on comparing the motion reference data from step 340 to the QR code 3D post estimation data from step 318 or to the feature point tracking data from step 322.

At step 342, processing circuitry sends a signal to a user display (e.g., user display 212, such as a dashboard display, or any other display). The signal may trigger an alert, e.g., that the trailer sway exceeds at least one threshold limit. On the other hand, the signal may indicate that trailer sway is currently less than a lower threshold limit. The signal may cause there to be any suitable indication on the user display, e.g., using a color indicator, showing a particular view of the trailer, showing a degree of sway, using any type of flashing, using any other suitable approach, or any combination thereof.

FIG. 4 shows an illustrative system 400 including a trailer equipped with a QR code for trailer sway monitoring. As shown, trailer 402 (e.g., which may be trailer 220) has QR code 404 (e.g., as may be detected at step 312, by processing circuitry of electric vehicle 202) applied to a surface of the trailer that faces a camera of the vehicle towing the trailer.

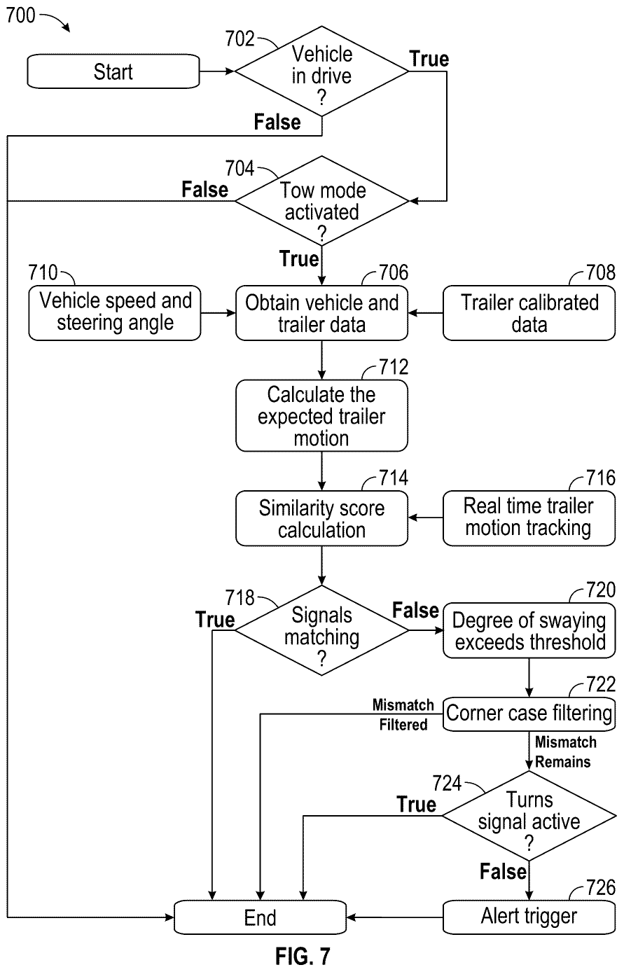

The QR code 404 may be tracked by the abovementioned feature extraction algorithm, or by any other suitable computer vision algorithm. QR code 404 may encode, or otherwise point to, data associated with trailer 402. For example, step 338 may include retrieving trailer data based on scanning QR code 404. A computer vision system (e.g., configured to execute computer vision algorithms, as described in connection with FIG. 3 and as further described at least in connection with FIGS. 5 and 7) may be configured to generate a frame around QR code 404, as indicated by bounding lines 406. To illustrate, inset 420 is provided with an exaggerated amount of spacing between bounding lines 406 and QR code 404. The computer vision system may further be configured to generate a projection line 408 (e.g., which may correspond to a 3D pose, as mentioned in connection with method 300) that is perpendicular to the QR code 404. Projection line 408 may be used to determine an orientation of the trailer 402, which may be used to determine a degree of trailer sway. It is noted that projection line 408 is shown as being offset from QR code 404, despite QR code 404 being flat with respect to the view shown in FIG. 4, for illustrative purposes only. In some embodiments, other feature points of trailer 402, such as feature points 410 and/or feature points 412, may be tracked and monitored (e.g., instead of or in addition to tracking and monitoring the position of QR code 404). For example, the other feature points may include edges, corners, wheels, bolts, fasteners, any other suitable visual identifiers, or any combination thereof.

In some embodiments, a user interface (e.g., on user display 212, or on a smart phone device or PC) is provided for a driver of the electric vehicle to encode trailer data into QR code 404 and/or print the QR code 404, such that it can be applied to any suitable location of trailer 402. For example, the electric vehicle driver may enter trailer dimensions and/or typical payload weight as the trailer data. Thereafter, the driver can attach the QR code to the trailer for trailer-data-assisted trailer sway monitoring (e.g., in connection with method 300, 700, 900, or 1000, or any other method consistent with embodiments of this disclosure, or any combination thereof). QR code 404 may be attached to the trailer's front-facing area (within view of at least one camera or other device among sensors 208), such as near the center of the trailer's front-facing area. Compared to the feature extraction method relying on features besides a QR code, tracking QR code 404 can provide a more repeatable, reliable, and trailer-specific approach to trailer sway monitoring.

To reiterate, trailer sway may be estimated by leveraging feature points (e.g., feature points 410 or 412, or any other suitable locations of trailer 402) or QR code 404 (possibly in addition to other QR codes on trailer 402) placed on the trailer. This approach can provide precise trailer tracking and accurate trailer sway estimation, thereby facilitating trailer sway monitoring. As mentioned, methods consistent with embodiments of this disclosure may use computer vision techniques (e.g., which may be used along with sensor fusion or other processing techniques) to detect and track high-contrast feature points of the trailer, and/or to track QR code 404 or other features points of the trailer. QR codes or other optical signatures may be implemented as feature points because they can contain trailer data and can be readily monitored by computer vision systems.

FIG. 5 shows an illustrative system of a vehicle 501 (e.g., which may be electric vehicle 202) using computer vision analysis to track trailer sway based on the position of QR code 404. Compared to the head-on view of FIG. 4, FIG. 5 shows a perspective view of trailer 402. For example, the view of FIG. 4 may correspond to a trailer being towed in direct alignment with respect to a vehicle, and the view of FIG. 5 may correspond to a trailer being towed with some angle of sway with respect to the vehicle. As shown in FIG. 5, during trailer sway detection (e.g., in connection with method 300, 700, 900, or 1000, or other processes consistent with embodiments of this disclosure), bounding lines 506 are determined around QR code 404, and perpendicular projection line 508 (e.g., which may correspond to a 3D pose, as mentioned in connection with method 300) is further determined based at least on the orientation of the bounding lines 506. That is, suitable markers (i.e., at least one feature point or at least one QR code) are detected in a 2D image plane, and these data are used to transform the 2D location information into 3D coordinates (e.g., as may be determined based on at least one of the bounding lines 506 and the projection line 508). The 3D coordinates may refer to, or be used to calculate, a 3D pose. By performing this transformation, processing circuitry of the vehicle may estimate the trailer's movement through 3D space, including estimating the trailer sway. In some embodiments, feature points other than a QR code are used (e.g., any of the feature points mentioned in connection with FIG. 4), and the computer vision algorithm is configured to determine bounding lines and a projection line corresponding to whatever one or more feature points are tracked for trailer sway monitoring.

In some embodiments, by analyzing the trajectory of the 3D coordinates of the markers, the system calculates the trailer sway (e.g., at step 324, or at step 712). This calculation may involve determining the displacement and angular deviations of the trailer with respect to a baseline position. The baseline position may be a moving average that is calculated in real time (or near real time) based, e.g., on vehicle speed, road curvature, turns, angles of incline/decline, or any other suitable consideration. For example, the baseline position may represent a trailer that is towed in perfect alignment with the vehicle (i.e., zero trailer sway). Thus, the displacement or angular deviation between projection line 508 and the baseline position may be used to determine how skewed the trailer is with respect to the rear of the vehicle towing the trailer, which is indicative of the trailer sway.

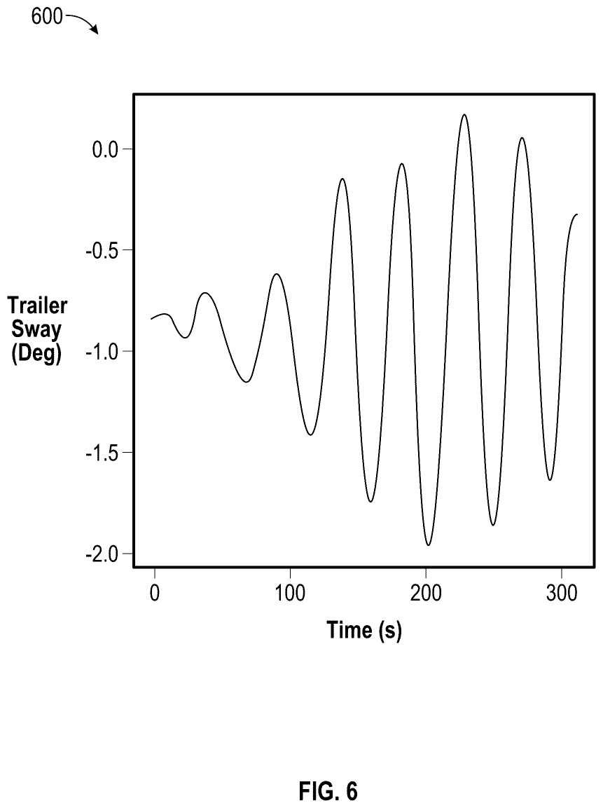

FIG. 6 shows an illustrative graph 600 of trailer sway (in degrees, which is one illustrative unit for measuring sway) versus time (e.g., in seconds). For example, the data of illustrative graph 600 may be generated by processing circuitry 210. Trailer sway as shown in FIG. 6 may be defined as the angle between the vehicle (e.g., electric vehicle 202) that is doing the towing and the trailer that is being towed (e.g., trailer 220). The data of graph 600 may be generated using any suitable approach for monitoring trailer sway described in this disclosure, including, but not limited to, the following illustrative examples.

As one example of generating the data of graph 600, a vehicle coordinate frame may be generated and a trailer coordinate frame may be generated, and the trailer sway may be defined based on the angles between the centers of the respective coordinate frames. As shown in FIG. 6, the trailer sway may oscillate with a peak-to-peak magnitude that generally increases over time. Thus, the trailer may be approaching a threshold level of sway. It is noted that the degrees shown in FIG. 6 are merely illustrative, and systems described in this disclosure may operate with any degree of precision as is needed to mitigate trailer sway.

As another example of generating the data of graph 600, when there is trailer sway, the pixel location of a feature point on the trailer may vary over time (e.g., by moving left, moving right, or oscillating between moving left and right, more than would be indicated by a baseline position). The incorporation of trailer data, vehicle data, and/or environmental data may indicate an acceptable amount of pixel movement (i.e., that would correspond to being below a threshold amount of trailer sway) for current driving conditions. Therefore, the amount of trailer sway may be determined by the horizontal change in pixel location, which can be compared to a threshold amount of pixel change for triggering an alert. Moreover, the amount of pixel movement, as compared to the baseline position, may be used to calculate the degrees of trailer sway, and then a warning may be triggered based on comparison to a threshold number of degrees.

As another example of generating the data of graph 600, the position of lane lines may be monitored. The monitored lane line position may be compared to the position of at least one vehicle wheel (e.g., to generate a baseline position) and may be further compared to the position of at least one trailer wheel (e.g., to generate a tracked position). The difference between those comparisons (i.e., the relationship between vehicle wheel and lane line, versus the relationship between trailer wheel and lane line) may be used to determine an amount of trailer sway. Therefore, the amount of trailer sway may be determined by lane and wheel tracking, and an alert can be triggered when there is a threshold discrepancy between those two positional relationships. Moreover, the discrepancy between those two positional relationships may be used to calculate the degrees of trailer sway, and then a warning may be triggered based on comparison to a threshold number of degrees.

In some embodiments, when using non-QR code feature points for trailer sway estimation, the processing circuitry is configured to avoid false feature point detections using any suitable statistical consistency measure, such as the signal variance. For example, if the variance in the motion data of a feature point exceeds a predefined threshold (e.g., within a sliding temporal window), then that feature point can be discarded. This approach for avoiding reliance on inconsistent feature points may increase accuracy of the trailer sway estimation. This approach may also provide smooth real-time estimation of trailer sway, as shown in FIG. 6.

In some embodiments, setting up certain trailer sway monitoring approaches provided in this disclosure includes the driver aligning the trailer with the vehicle (e.g., by slowly driving forward for a short distance). When the trailer is straight and aligned with the vehicle, the positions of the extracted feature points and/or QR-markers can be stored in memory (e.g., memory 216) as the initial tracking positions (e.g., which may, but need not, correspond to the baseline position). That is, any method described in this disclosure, or consistent with embodiments of this disclosure, may include the aforementioned setup procedure for the sake of calibrating the trailer sway monitoring and mitigation system.

If the processing circuitry performing the trailer sway monitoring detects (e.g., based on the feature extraction algorithm) that the initial feature point position deviates significantly from the expected position, then the driver may be prompted to recalibrate the system (e.g., system 200). Upon a successful calibration, the corresponding feature point position may be written to (or updated) and stored in memory (e.g., memory 216).

In some embodiments, reference data may be retrieved to support trailer sway monitoring. For example, the reference data may be trailer data, may correspond to motion tracking that is recorded when a trailer is in tow, and/or may correspond to trailer sway data collected for various trailer dimensions, loads, and speeds. The reference data may be used to bound any one or more of the aforementioned trailer sway algorithms to mitigate the possibility of outlying or unexpected trailer sway measurements (e.g., as may caused by various possible driving conditions). The reference data may be included in the motion reference data received at step 340, or the reference data may otherwise be used by alert logic of step 330 (e.g., to set one or more threshold associated with one or more trailer sway limit). In some embodiments, the reference data may be generated under factory conditions, transmitted to electric vehicle 202 via OTA (over-the-air) software updates, and stored in memory 216.

In some embodiments, a driver may be prompted to input trailer dimension information (e.g., small, medium, large, huge) and load information every time that a trailer is mechanically coupled to the vehicle. That is, besides gathering trailer data 338 from a QR code, a driver may directly provide that data for storage in memory 216. One or more of the algorithms provided herein for trailer sway monitoring may determine a threshold limit for permissible swaying (e.g., no less than 1 degree, no less than 5 degrees, or any other suitable amount of trailer sway) based at least in part based on the provided trailer dimension and load information, as well as the reference data.

FIG. 7 shows an illustrative flowchart of a method 700 for triggering an alert based on trailer sway monitoring. As described below, certain steps of method 700 may correspond to steps of method 300, method 900, method 1000, or any combination thereof. Method 700 may be executed by processing circuitry 210, may result in an alert being triggered on a user display 212, and may further result in vehicle controller 214 taking action to mitigate trailer sway. Method 700 may be executed to monitor and mitigate sway of trailer 220.

At step 702, processing circuitry determines that the vehicle (e.g., electric vehicle 202, or vehicle 501) is in drive. At step 704, the processing circuitry determines that a tow mode of the vehicle is activated (i.e., the vehicle is towing any cargo, including but not limited to trailer 220). If either of the respective determinations at step 702 or at step 704 are false, then method 700 does not proceed; otherwise, method 700 proceeds as further shown in FIG. 7.

At step 706, the processing circuitry obtains trailer data 708 and/or vehicle data 710 (e.g., using sensors 208, suitable processing of received data, and/or retrieval from memory 216), which may be based on at least one of vehicle speed, steering angle data, or trailer calibrated data. For example, vehicle speed and steering angle of step 336 may correspond to vehicle speed and steering angle data 710, and trailer data of step 338 may correspond to trailer calibrated data 708.

At step 712, the processing circuitry calculates the expected trailer motion. For example, the expected trailer motion may correspond to the aforementioned baseline position. The expected trailer motion (e.g., without sway) is calculated based on the vehicle and trailer data.

At step 714, the processing circuitry compares the expected trailer motion to real-time trailer motion tracking data (e.g., as recorded at sensors 208), as received at step 716, to determine a similarity score. In other words, processing circuitry (e.g., based on any of the abovementioned algorithms) determines how similar the true trailer motion is to the expected trailer motion, with the difference indicating the trailer sway as a similarity score.

At step 718, the processing circuitry determines whether the expected and tracked trailer motion signals match. For example, step 718 may include comparing the similarity score from 714 with any suitable threshold. A low similarity score may indicate a mismatch, and a high similarity score may indicate a match. If there is a mismatch, the processing circuitry may determine that the trailer is not swaying and no further operations are needed.

At step 720, if the processing circuitry determines that there is a mismatch between the expected and tracked trailer motion signals, then the processing circuitry makes a preliminary determination that the degree of swaying exceeds a threshold. For example, step 720 may correspond to step 324. For another example, step 720 may include monitoring the trailer sway data as shown in FIG. 6.

At step 722, in some embodiments, the processing circuitry filters out corner cases (e.g., outlier events based on a bump in the road, a temporary camera occlusion, or any other stochastic event). As shown, it is possible that the filtering eliminates or otherwise resolves the signal mismatch found at step 718 (i.e., the mismatch is filtered out), causing method 700 to avoid triggering an alert. Otherwise, method 700 proceeds to step 724.

At step 724, the processing circuitry checks whether a turn signal is active. If the turn signal is active, the processing circuitry determines that a trailer sway alert should not be triggered, e.g., because the signal mismatch determined at step 718 is due to the turning trajectory. For example, step 724 may correspond to step 332. In response to making a “true” determination at step 724, the processing circuitry may be configured to repeat method 700 after a sufficient delay (e.g., after the turn has completed).

At step 726, an alert is triggered (e.g., on user display 212) to let the driver know that trailer sway is occurring. The alert may be any of the alerts described above. For example, step 726 may correspond to step 342. The alert may indicate the degree of trailer sway. The alert may indicate a recommended action (e.g., to decelerate, brake, or turn in a particular direction). In some embodiments, the processing circuitry is further configured to cause vehicle controller 214 to perform the recommended action (e.g., in response to approval from the driver, or after the driver has failed to correct for the trailer sway for a threshold amount of time).

To summarize method 700, algorithmic steps are performed (e.g., at least at steps 706, 712, and 714) to trigger an alert when the estimated trailer swaying exceeds a desired range (e.g., the signals do not match at step 718). The vehicle speed, steering angle (e.g., as determined based on a position of the steering wheel), and/or trailer calibrated data may be used to establish an acceptable reference motion trajectory (e.g., which may correspond to the motion reference of step 340). This reference motion trajectory may be the expected trailer motion 712, and/or it may be considered at step 714.

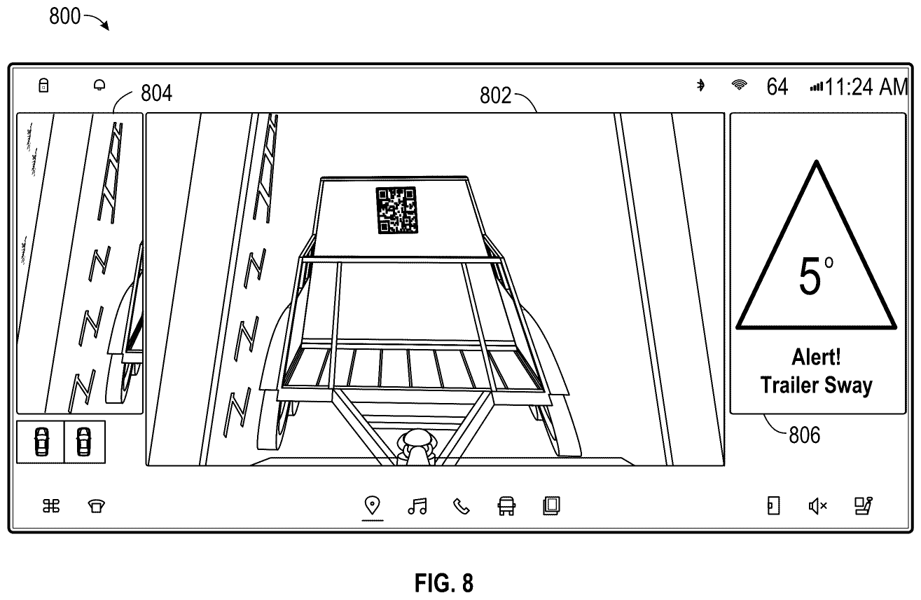

FIG. 8 shows an illustrative display panel 800 (e.g., a whole or part of user display 212) including a trailer sway alert. Any one or more components as shown in display panel 800 may be rendered on a user display in accordance with trailer sway monitoring. Display panel 800 includes central display 802, which shows a rear-facing view of a trailer (e.g., trailer 402) that is being towed by a vehicle (e.g., electric vehicle 202, or vehicle 501) including the illustrative display panel. Display panel 800 includes first side display 804, which shows a side view of the trailer. The first side display 804 may be configured to show the side of a trailer that is, e.g., veering too far over (e.g., into a neighboring lane, or toward an edge of the road). In some embodiments, the first side display 804 is configured to show up on the left or right side of central display 802 based on which side of the trailer is veering too far over. Display panel 800 also includes second side display 806, which shows a degree of trailer sway (e.g., five degrees, as shown, or any other amount of degrees) and a corresponding warning message (e.g., as generated by alert logic of step 330 or alert trigger of step 726).

In some embodiments, the state of trailer sway (e.g., as determined using method 300, 700, 900, 1000, or any combination thereof) is color-coded into an alert (or possibly a normal status message) that is triggered for the user (e.g., on any suitable portion of display panel 800, or on any other user display 212). For example, second side display 806 may be configured to display the trailer sway as red when the sway is five degrees (i.e., the amount of sway is in a “red” range, above an upper threshold), as yellow when the sway is above one degree (i.e., the amount of sway is in a “yellow” range, above a lower threshold and below an upper threshold), and as green when the sway is less than one degree (i.e., the amount of sway is in a “green” range, below a lower threshold). Based on the amount of trailer sway, a corresponding message may be rendered (e.g., as generated by alert logic of step 330 or alert trigger of step 726). For example, the corresponding message could say “Check Trailer” when the amount sway is in a yellow range, and the message could say “Alert! Trailer Sway” when the amount of sway is in a red range.

In some embodiments, if a user display (e.g., user display 212) of the vehicle is not showing the output of a camera (e.g., the camera app or view may not be enabled), but the trailer sway estimate triggers an alert that corresponds to a red or yellow indicator code, then processing circuitry (e.g., processing circuitry 210) may cause a trailer camera view and/or a visual gauge quantifying trailer sway to automatically pop up on the user display screen. For example, display panel 800 may be showing any other suitable information or entertainment displays, and in response to the trailer sway exceeding a threshold, display panel 800 automatically reconfigures to show one or more of the central display 802, first side display 804, or second side display 806.

In some embodiments, the trailer sway alert may be configured to trigger in the form of a predefined and/or familiar visual and/or audio warning. In some embodiments, the alert may be configured to trigger in a manner that is similar to a rear cross traffic alert (RCTA). For example, a camera view of the trailer may be displayed (e.g., as in central display 802), and a red banner with arrows indicating the direction of trailer sway may be overlaid on the camera view of the trailer. In some embodiments, warning text (e.g., “Trailer Sway” or “Alert! Trailer Sway”) may appear on the screen. In some embodiments, audio cues (e.g., beeping and/or an announcement of the warning text) indicating the trailer sway may be triggered (e.g., in place of or in addition to the visual warning cues). These audio cues may be a part of a response generated by alert logic of step 330 or alert trigger of step 726.

In some embodiments, multi-sensor fusion is performed for trailer sway detection. For example, sensors 208 may also (e.g., in addition to one or more cameras) include LIDAR, RADAR, USS, and/or inertial measurement units (IMUs). Those sensors can provide additional data for detecting and analyzing trailer sway, such as lateral forces and angular velocity. Multi-sensor fusion may increase the accuracy and reliability of sway detection under various environmental and lighting conditions.

In some embodiments, trailer sway detection and mitigation is provided at least in part by an augmented reality (AR) algorithm, such as an AR driving assistant. For example, AR techniques may be used to generate a 3D rendering of the trailer based on 2D camera or other sensors 208 data. For example, an AR display (e.g., on user display 212 or display panel 800) may overlay critical towing information directly onto an AR rendering, a camera-recorded scene, and/or any preferred (e.g., based on preferences of a driver of electric vehicle 202) panel display. The AR display may include trailer sway status (e.g., a color-coded indicator and optionally a degree of sway), trailer alignment tips, or corrective action prompts. Any one or more of these AR components may be referred to as an AR system. The AR system can visually guide the driver to cause a real-time adjustment or to prompt the driver to stop and check the trailer. As part of the AR system, AR driving assistance may improve driver awareness and compliance with sway mitigation steps, thereby providing improved situational awareness while towing a trailer or any other suitable cargo.

In other words, the AR system may be configured to cause the vehicle to mitigate the trailer sway. In some embodiments, the AR system may be further configured to determine that the driver has not sufficiently mitigated sway, in which case the AR system may be further configured to implement an ADAS operation to mitigate the sway. The ADAS operation may include decelerating, braking, or turning the vehicle.

In some embodiments, trailer sway detection and mitigation is provided at least in part by an artificial intelligence (AI), such as a deep-learning algorithm or an algorithm with behavior prediction. Any such system relying on an AI algorithm may be referred to as an AI system. Processing circuitry (e.g., processing circuitry 210, or remote processing circuitry that is communicatively coupled to processing circuitry 210) may implement the AI system, which can learn from driver habits and/or historical trailer sway, to predict future trailer sway before it occurs (or before it reaches a threshold amount of trailer sway, e.g., before reaching a yellow color-coded alert). For example, the AI system may be configured to analyze typical vehicle/trailer routes, speeds, and loads to anticipate conditions that might lead to trailer sway. As with the AR system, the AI system may be configured to determine that the driver has not sufficiently mitigated sway and to thus implement an ADAS operation to mitigate the sway.

In some embodiments, processing circuitry 210 includes at least one GPU configured to operate at least part of an AR system, at least part of an AI system, or at least parts of both.

In some embodiments, trailer sway detection is provided to detect trailer sway occurring in nearby vehicles (i.e., the vehicle performing the trailer sway is driving close to another vehicle that is towing a trailer, or any other cargo, which is experiencing sway). For example, sensors 208 may include front and/or side cameras, and whether or not electric vehicle 202 is towing trailer 220, processing circuitry 210 may execute methods provided by the subject matter of this disclosure (e.g., at least part of any of methods 300, 700, 900, or 1000, or any combination thereof) to determine whether a different vehicle is towing a trailer with excess sway. The trailer sway detection may apply the computer vision system to detect and track nearby vehicle trailers and estimate the amount of trailer sway of those nearby vehicle trailers. Based on the estimated amount of trailer sway, the trailer sway detection system can warn the driver of a potential trailer sway hazard resulting from another driver's behavior. Nearby trailer sway detection may improve driver awareness of excess trailer sway in nearby vehicles, and provide early indications of such trailer sway.

In some embodiments, trailer sway detection is provided for automatic recording of hazardous trailer swaying for insurance purposes. For example, an advanced notification system (e.g., which may be similar to, or an extension of, the aforementioned alert and warning trigger system) may customize alerts based on the amount of the trailer sway and/or contextual data such as vehicle speed and lighting conditions. In some embodiments, the system is configured to prioritize certain alerts (e.g., based on the details of the condition triggering the alert). In some embodiments, the system is configured to suggest a sequence of actions in a tiered manner. Automatic recording of hazardous trailer swaying may provide evidence to be used in connection with insurance obligations.

In some embodiments, trailer sway detection and mitigation includes an automatic application of vehicle braking and/or trailer braking after swaying is detected. For example, if the vehicle (e.g., electric vehicle 202) towing the trailer (e.g., trailer 220) is connected to the trailer's electrical braking system (e.g., through a trailer brake controller), then an automatic mechanism for applying trailer brakes can be implemented. This automatic mechanism would apply brakes to the trailer (and, optionally, to the vehicle) depending on the speed of vehicle, steering angle, trailer load, amount of sway detected, road or weather conditions, any other suitable criteria, or any combination thereof. The automated trailer braking may enhance responsive mitigation capabilities of the system when trailer sway is detected to help reduce trailer sway. In some embodiments, the automated trailer braking is an illustrative ADAS operation implemented to mitigate trailer sway.

In some embodiments, trailer sway detection and mitigation includes automatic vehicle control to mitigate swaying. For example, a torque of electric motor 204 and/or an output of battery 206 may be controlled by processing circuitry 210 based on the detection of trailer sway to mitigate the trailer sway. Automatic vehicle control may be used in parallel with application of trailer braking (e.g., to brake the vehicle in coordination with braking the trailer). The motor torque can be adjusted based on the towing vehicle's speed, drive mode, proximity to other objects/vehicles, steering angle, and/or other real-time inputs from sensors 208 of the electric vehicle 202. In some embodiments, processing circuitry 210 executes an algorithm to adjust the torque (e.g., based on reinforcement learning techniques, or any other suitable AI algorithm). The torque-adjustment algorithm may be configured to learn the appropriate torque response over time to mitigate various possible amounts of trailer sway, e.g., according to corresponding vehicle speeds, trailer loads, and other factors. For example, a reinforcement learning algorithm may improve over time by being rewarded when an applied torque change successfully reduces trailer swaying. The vehicle control may enhance responsive mitigation capabilities of the system when trailer sway is detected to help reduce trailer sway.

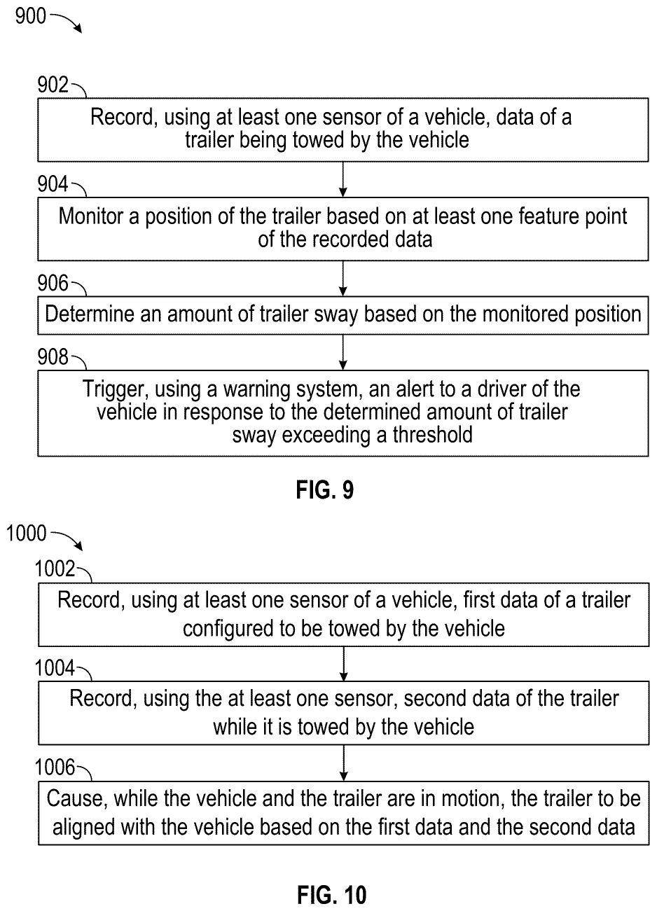

FIG. 9 is a flowchart of an illustrative method 900 for trailer sway monitoring and mitigation, in accordance with some embodiments of this disclosure. Method 900 may be performed by electric vehicle 202, vehicle 501, or any other suitable vehicle (e.g., any vehicle that is equipped with at least one sensor 208 and with processing circuitry 210, and that is towing a trailer 220 or any other suitable cargo). Method 900 may include at least some operations as described in connection with method 300 and/or at least some operations as described in connection with method 700.

Step 902 includes recording, using at least one sensor (e.g., a camera, ultrasound sensor, or any other device capable of providing spatiotemporal information) of a vehicle (e.g., electric vehicle 202, or vehicle 501), data of a trailer (e.g., trailer 220 or trailer 402) being towed by the vehicle. The data may include visual data, e.g., as provided by any one or more device of sensors 208.

Step 904 includes monitoring a position of the trailer based on at least one feature point of the recorded data. The at least one feature point may be any optical signature (e.g., QR code 404 or a bar code), a feature point 410, a feature point 412, any other suitable feature point, or any combination thereof. Monitoring the position of the trailer may include tracking the position of the feature over time.

Step 906 includes determining an amount of trailer sway based on the monitored position. For example, the amount of trailer sway may be determined as a degree of trailer sway that is monitored over time, as shown in FIG. 6. Determining the amount of trailer sway may include the use of any techniques described in connection with method 300 or 700. Determining the amount of trailer sway may include the use of computer vision systems, computational operations, AR systems, AI systems, or any combination thereof.

Step 908 includes triggering, using a warning system, an alert to a driver (e.g., using user display 212, or display panel 800) of the vehicle in response to the determined amount of trailer sway exceeding a threshold. The trigger may include showing one or more of the three displays shown in FIG. 8. The trigger may be based on data of the trailer (e.g., a weight of the trailer), which may be determined based on the feature point. For example, the weight may be encoded into a QR code, or the weight may be estimated based on computer vision analysis of a cargo load, including its dimensions and estimated density.

FIG. 10 is a flowchart of an illustrative method 1000 for trailer sway monitoring calibration and trailer sway mitigation, in accordance with some embodiments of this disclosure. Method 1000 may be performed by electric vehicle 202, vehicle 501, or any other suitable vehicle (e.g., any vehicle that is equipped with at least one sensor 208 and with processing circuitry 210, and that is towing a trailer 220 or any other suitable cargo). Method 1000 may include at least some operations as described in connection with method 300, at least some operations as described in connection with method 700, and/or at least some operations as described in connection with method 900.

Step 1002 includes recording, using at least one sensor of a vehicle, first data of a trailer configured to be towed by the vehicle. Step 1002 may serve to calibrate a trailer sway monitoring system, e.g., before the vehicle is in motion, or when the vehicle is moving sufficiently controllably or slowly that any possible trailer sway can be neglected. Step 1002 may include generating baseline position data, as mentioned above.

Step 1004 includes recording, using the at least one sensor, second data of the trailer while it is towed by the vehicle. For example, step 1004 may include the execution of method 900. The second data may indicate that the degree of trailer sway has exceeded a threshold. Comparing the second data to the first data may include comparing a current trailer trajectory to a baseline position.

Step 1006 includes causing, while the vehicle and the trailer are in motion, the trailer to be aligned with the vehicle based on the first data and the second data. For example, step 1006 may include issuing an alert to the driver based on a determination by alert logic of step 330 or alert trigger of step 726. For another example, step 1006 may include recommending a mitigation action to the driver (e.g., by issuing an indication on user display 212 or display panel 800). For another example, step 1006 may include implementing one or more ADAS operation (e.g., as executed by processing circuitry 210, an AR system, an AI system, or any other suitable device). The one or more ADAS operation may include decelerating the vehicle, braking the vehicle, turning the vehicle, or otherwise causing the trailer to be aligned with the vehicle.

The processes described above are intended to be illustrative and not limiting. One skilled in the art would appreciate that the steps of the processes described herein may be omitted, modified, combined and/or rearranged, and any additional steps may be performed without departing from the scope of the invention.

The foregoing is merely illustrative of the principles of this disclosure, and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations thereto and modifications thereof, which are within the spirit of the following claims.

What is claimed is:

1. A vehicle comprising:
at least one sensor configured to record data of a trailer coupled to the vehicle;
processing circuitry configured to:
monitor a position of the trailer based on at least one feature point of the recorded data; and
determine an amount of trailer sway based on the monitored position; and
a warning system configured to trigger an alert to a driver of the vehicle in response to the determined amount of trailer sway exceeding a threshold.

2. The vehicle of claim 1, wherein the at least one sensor comprises a camera and at least one of an ultrasonic sensor, a LIDAR sensor, a RADAR sensor, or an inertial measurement unit.

3. The vehicle of claim 1, wherein the processing circuitry is further configured to detect an optical signature, and the at least one feature point comprises the optical signature.

4. The vehicle of claim 3, wherein:
the optical signature encodes data of the trailer; and
the threshold is based on the data of the trailer.

5. The vehicle of claim 4, wherein:
the data of the trailer comprises at least one of a trailer load, trailer dimensions, or trailer weight distribution; and
the processing circuitry is configured to determine the amount of trailer sway further based on the data of the trailer.

6. The vehicle of claim 1, wherein the at least one sensor is further configured to adjust an aspect of the data recording based on at least one of a speed of the vehicle or an environmental condition.

7. The vehicle of claim 1, wherein the warning system is configured to trigger an occlusion alert in response to an occlusion of the at least one sensor.

8. The vehicle of claim 1, wherein:
the processing circuitry is further configured to determine an estimated position of the trailer;
the estimated position does not account for trailer sway; and
the processing circuitry is configured to determine the amount of trailer sway further based on a difference between the monitored position and the estimated position.

9. The vehicle of claim 1, wherein the processing circuitry is further configured to cause the vehicle to mitigate the trailer sway in response to the determined amount of trailer sway exceeding the threshold.

10. The vehicle of claim 9, wherein the processing circuitry is configured to cause the vehicle to mitigate the trailer sway by at least one of applying a brake to the trailer or adjusting a torque of the vehicle.

11. A method comprising:
recording, using at least one sensor of a vehicle, data of a trailer being towed by the vehicle;
monitoring a position of the trailer based on at least one feature point of the recorded data;
determining an amount of trailer sway based on the monitored position; and
triggering, using a warning system, an alert to a driver of the vehicle in response to the determined amount of trailer sway exceeding a threshold.

12. The method of claim 11, wherein the at least one sensor comprises a camera and at least one of an ultrasonic sensor, a LIDAR sensor, a RADAR sensor, or an inertial measurement unit.

13. The method of claim 11, wherein the at least one feature point comprises an optical signature coupled to the trailer.

14. The method of claim 13, wherein the optical signature encodes data of the trailer, and wherein the threshold is based on the data of the trailer.

15. The method of claim 14, wherein the data of the trailer comprises at least one of a trailer load, trailer dimensions, or trailer weight distribution, and wherein determining the amount of trailer sway is further based on the data of the trailer.

16. The method of claim 11, further comprising adjusting an aspect of the recording based on at least one of a speed of the vehicle or an environmental condition.

17. The method of claim 11, further comprising issuing triggering an occlusion alert in response to an occlusion of the at least one sensor.

18. The method of claim 11, further comprising causing the vehicle to mitigate the trailer sway in response to the determined amount of trailer sway exceeding the threshold, wherein the mitigating comprises at least one of applying a brake to the trailer or modifying a torque of the vehicle.

19. A method comprising:
recording, using at least one sensor of a vehicle, first data of a trailer configured to be towed by the vehicle;
recording, using the at least one sensor, second data of the trailer while it is towed by the vehicle; and
causing, while the vehicle and the trailer are in motion, the trailer to be aligned with the vehicle based on the first data and the second data.

20. The method of claim 19, further comprising estimating a computed trajectory of the trailer based on the alignment, monitoring a recorded trajectory of the trailer based on the second data, and determining an amount of sway of the trailer by comparing the estimated trajectory to the recorded trajectory, wherein causing the trailer to be aligned is further based on the amount of sway of the trailer.
